(19) United States
(12) Patent Application Publication
(10) Pub. No.: US 2025/0279491 A1
(43) Pub. Date: Sep. 4, 2025

(54) DEAERATION OF TRACTION BATTERY THERMAL MANAGEMENT COOLANT CIRCUITS

(71) Applicant: FORD GLOBAL TECHNOLOGIES, LLC, Dearborn, MI (US)

(72) Inventor: Ronald Richard SEMEL, West Bloomfield, MI (US)

(21) Appl. No.: 18/593,073

(22) Filed: Mar. 1, 2024

(51) Int. Cl. H01M 10/52; B60L 58/26; H01M 10/63; H01M 10/66

(52) U.S. Cl. CPC H01M 10/52; B60L 58/26; H01M 10/63; H01M 10/66; B60L 2240/545

(57) ABSTRACT

Thermal management systems are provided for managing the thermal energy levels of a traction battery pack of an electrified vehicle. An exemplary thermal management system may include a gas separator and a reservoir. The gas separator may remove entrained gases (air, vent byproducts, etc.) from a coolant circulated through the system during both normal operating conditions and during battery thermal events that require increased coolant volume and flow rates for mitigating convective heat transfer. The removed gases can be expelled to atmosphere from within the reservoir. A pump for circulating the coolant through the system may be controlled based on a temperature of the coolant exiting the traction battery pack as part of a deaeration control strategy.

### TECHNICAL FIELD

This disclosure relates generally to electrified vehicles, and more particularly to battery thermal management systems capable of deaerating a coolant circuit during both normal operating operations and during battery thermal events.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A thermal management system for an electrified vehicle according to an exemplary aspect of the present disclosure includes, among other things, a traction battery pack, a pump configured to circulate a coolant through the traction battery pack, a gas separator configured to deaerate the coolant, a reservoir configured to receive a gas removed from the coolant from within the gas separator, and a control module programmed to configured to control the pump based on a temperature of the coolant exiting the traction battery pack.

In a further non-limiting embodiment of the foregoing thermal management system, the thermal management system is an immersion thermal management system.

In a further non-limiting embodiment of either of the foregoing thermal management systems, the coolant is a dielectric fluid.

In a further non-limiting embodiment of any of the foregoing thermal management systems, the gas separator is packaged at a first location of the electrified vehicle, and the reservoir is packaged at a second location of the electrified vehicle. The second location is vertically higher than the first location.

In a further non-limiting embodiment of any of the foregoing thermal management systems, the first location is near an outlet of the traction battery pack, and the second location is at a highest point of a coolant circuit of the thermal management system.

In a further non-limiting embodiment of any of the foregoing thermal management systems, the gas includes air.

In a further non-limiting embodiment of any of the foregoing thermal management systems, the gas includes a vent byproduct released by a battery cell of the traction battery pack.

In a further non-limiting embodiment of any of the foregoing thermal management systems, a temperature sensor is configured to sense the temperature.

In a further non-limiting embodiment of any of the foregoing thermal management systems, the control module is programmed to command the pump to operate at a first speed when the temperature is less than a predefined temperature threshold.

In a further non-limiting embodiment of any of the foregoing thermal management systems, the control module is programmed to command the pump to operate at a second, greater speed when the temperature is greater than the predefined temperature threshold.

In a further non-limiting embodiment of any of the foregoing thermal management systems, the gas separator is configured to remove air from the coolant during the first speed and is further configured to remove a vent byproduct released by a battery cell of the traction battery pack during the second, greater speed.

In a further non-limiting embodiment of any of the foregoing thermal management systems, a heat exchanger is configured to cool the coolant prior to the coolant being returned to the traction battery pack.

In a further non-limiting embodiment of any of the foregoing thermal management systems, the heat exchanger is a radiator.

A method according to another exemplary aspect of the present disclosure includes, among other things, circulating a coolant through a traction battery pack, sensing a temperature of the coolant exiting from the traction battery pack, controlling a pump to operate at a first speed when the temperature is less than a predefined temperature threshold, removing air from the coolant within a gas separator when the pump is operated at the first speed, controlling the pump to operate at a second speed that is greater than the first speed when the temperature is greater than the predefined temperature threshold, and removing a vent byproduct released by a battery cell of the traction battery pack within the gas separator when the pump is operated at the second speed.

In a further non-limiting embodiment of the foregoing method, the method includes transferring the air to a reservoir, and expelling the air to atmosphere from the reservoir.

In a further non-limiting embodiment of either of the foregoing methods, the gas separator is packaged at a first location, and the reservoir is packaged at a second location that is vertically higher than the first location.

In a further non-limiting embodiment of any of the foregoing methods, the method includes transferring the vent byproduct to a reservoir, and expelling the vent byproduct to atmosphere from the reservoir.

In a further non-limiting embodiment of any of the foregoing methods, the gas separator is packaged at a first location, and the reservoir is packaged at a second location that is vertically higher than the first location.

In a further non-limiting embodiment of any of the foregoing methods, the temperature is sensed by a temperature sensor located at or near an outlet of the traction battery pack.

In a further non-limiting embodiment of any of the foregoing methods, the gas separator is located between an outlet of the traction battery pack and an inlet of a heat exchanger.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 schematically illustrates a thermal management system for thermally managing a traction battery pack of an electrified vehicle.

FIG. 3 schematically illustrates a method of controlling a battery thermal management system.

### DETAILED DESCRIPTION

This disclosure details thermal management systems for managing the thermal energy levels of a traction battery pack of an electrified vehicle. An exemplary thermal management system may include a gas separator and a reservoir. The gas separator may remove entrained gases (air, vent byproducts, etc.) from a coolant circulated through the system during both normal operating conditions and during battery thermal events that require increased coolant volume and flow rates for mitigating convective heat transfer. The removed gases can be expelled to atmosphere from within the reservoir. A pump for circulating the coolant through the system may be controlled based on a temperature of the coolant exiting the traction battery pack as part of a deaeration control strategy. These and other features are discussed in greater detail in the following paragraphs of this detailed description.

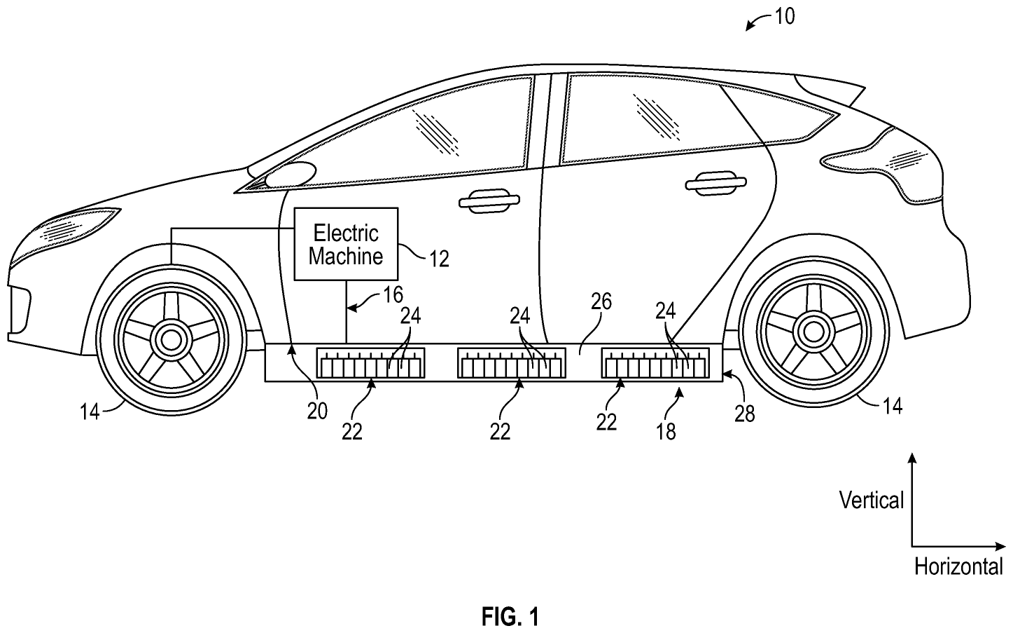

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The one or more battery arrays 22 of the traction battery pack 18 may each include a plurality of battery cells 24 that store energy for powering various electrical loads of the electrified vehicle 10. The traction battery pack 18 could employ any number of battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

Thermal energy levels within the traction battery pack 18 can increase as the electrified vehicle 10 is operated. This disclosure is therefore directed to thermal management systems that are capable of managing the thermal energy levels of the traction battery pack 18 while also providing degassing functions during various thermal operating conditions of the traction battery pack 18.

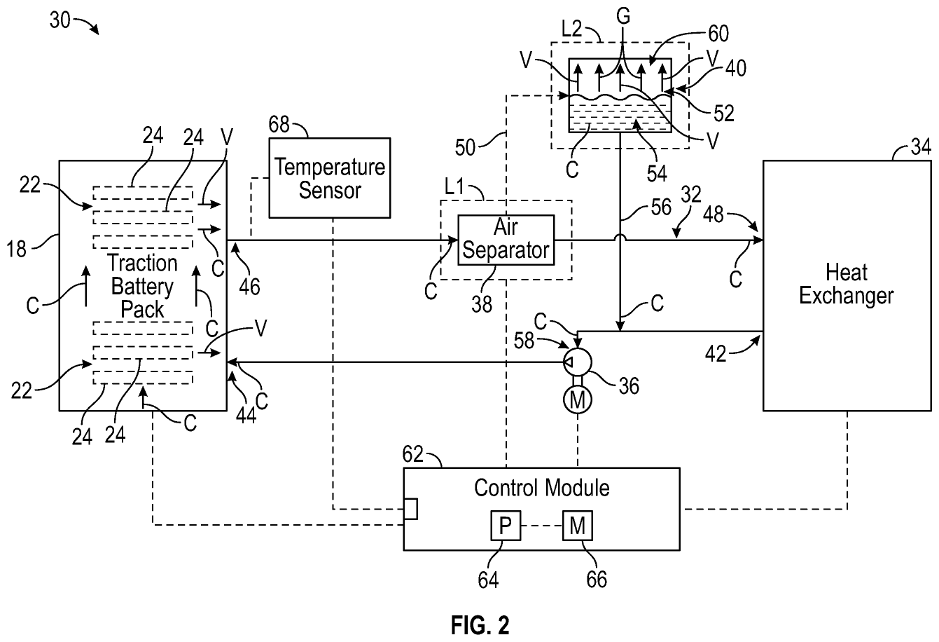

FIG. 2 schematically illustrates a thermal management system 30 that can be incorporated into an electrified vehicle, such as the electrified vehicle 10 of FIG. 1, for example, for managing the thermal loads generated by the traction battery pack 18 and/or another vehicle component(s). The thermal management system 30 can selectively communicate a coolant C through the traction battery pack 18 to remove heat from the battery cells 24 packaged inside the traction batter pack 18. Although only schematically shown, the various subcomponents of the thermal management system 30 can be fluidly interconnected by various conduits or passages such as tubes, hoses, pipes, etc.

The thermal management system 30 includes a coolant circuit 32 for circulating the coolant C to thermally manage the traction battery pack 18. In an embodiment, the coolant C is water mixed with ethylene glycol or another suitable coolant. In another embodiment, the thermal management system 30 is an immersion thermal management system and thus the coolant C can include a dielectric fluid or another type of non-conductive fluid (e.g., oil) that is designed for immersion cooling the battery cells 24. Immersion cooling involves immersing portions of the traction battery pack 18, such as the battery cells 24 of the battery arrays 22, in the coolant C.

The coolant circuit 32 may include at least a heat exchanger 34, a pump 36, a gas separator 38, and a reservoir 40. The gas separator 38 and the reservoir 40 may replace the conventional degas bottle typically utilized within prior thermal management systems. Conventional degas bottles can be less effective at removing air and/or other gases from the coolant circuit 32 in immersion type thermal management systems that typically require increased coolant volume and coolant flow rates.

During operation of the coolant circuit 32, thermal energy picked up from the traction battery pack 18 may be transferred from the coolant C to ambient air outside the electrified vehicle 10 within the heat exchanger 34. In an embodiment, the heat exchanger 34 is a radiator (i.e., a fluid-to-air heat exchanger). Thus, airflow may be drawn through the heat exchanger 34 for undergoing convective heat transfer with the coolant C. The airflow can exchange heat with the coolant C as the two fluids flow across/through the heat exchanger 34. The cooled coolant C may then be returned to the traction battery pack 18 as part of a closed loop of the coolant circuit 32.

The pump 36 may operate to circulate the coolant C through the coolant circuit 32. In an embodiment, the pump 36 is located between an outlet 42 of the heat exchanger 34 and an inlet 44 of the traction battery pack 18. However, the pump 36 could be located elsewhere within the coolant circuit 32. The pump 36 may be an electrically powered fluid pump or another type of pump within the scope of this disclosure.

The coolant C that is pumped through the traction battery pack 18 may take on thermal energy from the battery cells 24. The coolant C may then exit through an outlet 46 of the traction battery pack 18 prior to eventually being returned to an inlet 48 of the heat exchanger 34. Thermal energy of the coolant C may be rejected to atmosphere at the heat exchanger 34.

The gas separator 38 may be located between the outlet 46 of the traction battery pack 18 and the inlet 48 of the heat exchanger 34. The gas separator 38 may be configured to deaerate the coolant C circulated through the coolant circuit 32. Removing entrained gases G (e.g., air, etc.) from the coolant C can be important for providing proper circulation of the coolant C through the coolant circuit 32 during normal operating conditions of the traction battery pack 18, for example. The coolant C may enter the air separator 38 at a low point, undergo a spinning or cyclonic motion, and then exit a high point of the air separator 42 to cause the gas G to separate from the coolant C.

The gas separator 38 is fluidly connected to the reservoir 40 by a gas line 50. The reservoir 40 includes an interior area 52 that can hold a supply 54 of the coolant C. Coolant C from the supply 54 may be gravity fed through a fill line 56 to an inlet side 58 of the pump 36. The reservoir 40 may provide a sufficient pressure on the inlet side 58 of the pump 36 for reducing the likelihood of pump cavitation.

The interior area 52 of the reservoir 40 may further includes a gas region 60, which can receive the gases G deaerated from the coolant circuit 32. As the gas G is removed from the coolant circuit 32 by the gas separator 38 during normal operating conditions, the gas G can move vertically upward from the gas separator 38 through the gas line 50 and enter the gas region 60 of the reservoir 40. The gas G received within the gas region 60 may subsequently be expelled to atmosphere. The volume of the coolant circuit 32 previously occupied by the gas G can then be replaced with coolant C from the supply 54 via fill line 56.

One or more of the battery cells 24 packaged within the traction battery pack 18 can periodically release vent byproducts V during a battery thermal event. A battery thermal event may occur, for example, during an overcharge condition, an overdischarging condition, a short circuit, etc. The vent byproducts V can be released from the battery cells 24 through a vent and can include gases and effluent particles. Pressure increases within one of the battery cells 24 can cause the vent to rupture, thereby creating a path for the vent byproducts V to be released from inside the battery cell 24 during the battery thermal event.

The gas separator 38 may additionally be configured to remove gases and other effluents associated with the vent byproducts V from the coolant C during a battery thermal event of the traction battery pack 18. The vent byproducts V removed by the gas separator 38 may be delivered to the gas region 60 of the reservoir 40 through the gas line 50. The vent byproducts V received within the gas region 60 may subsequently be expelled to atmosphere, thereby quickly and efficiently expelling the vent byproducts V from the thermal management system 30 and reducing or even eliminating convective heat transfer across the coolant circuit 32 that could be caused by the vent byproducts V during the battery thermal event.

The gas separator 38 may be packaged at a first location L1 of the electrified vehicle 10, and the reservoir 40 may be packaged at a second location L2 of the electrified vehicle 10. In an embodiment, the first location L1 is near the outlet 46 of the traction battery pack 18, and the second location L2 is vertically higher than the first location L1. The second location L2 may be the vertically highest point of the coolant circuit 32, for example. Vertical, for purposes of this disclosure, are with reference to ground in the ordinary orientation of the vehicle 10 during its operation.

The thermal management system 30 may additionally include a control module 62. The control module 62 could be a stand-alone control unit associated with the thermal management system 30 or could be part of an overall vehicle control unit, such as a vehicle system controller (VSC) that includes a powertrain control unit, a transmission control unit, an engine control unit, a battery control module, etc. It should therefore be understood that the control module 62 and one or more other controllers can collectively be referred to as a “control module” that is configured to control, such as through a plurality of integrated algorithms, various actuators in response to signals from various input devices associated with the thermal management system 30. The various controllers that make up the VSC can communicate with one another using a common bus protocol (e.g., CAN), for example.

In an embodiment, the control module 62 is programmed with executable instructions for interfacing with and operating the various components of the thermal management system 30 for thermally managing the traction battery pack 18 and for deaerating the coolant C during both normal operating conditions and during battery thermal events of the traction battery pack 18. The control module 62 may include various inputs and outputs for interfacing with the various components of the thermal management system 30.

The control module 62 may include a processor 64 and non-transitory memory 66 for executing the various control strategies and modes of the thermal management system 30. The processor 64 can be a custom made or commercially available processor, a central processing unit (CPU), or generally any device for executing software instructions. The memory 66 can include volatile memory elements, nonvolatile memory elements, or a combination of both.

A temperature sensor 68 may be provided at or near the outlet 46 of the traction battery pack 18. The temperature sensor 68 may be operably connected to the control module 62 of the thermal management system 30 and may be configured to sense the temperature of the coolant C exiting the traction battery pack 18. Alternatively, a pressure sensor could be packaged within the traction battery pack 18 for inferring battery thermal events.

When the temperature sensed by the temperature sensor 68 is less than a predefined temperature threshold (e.g., about 60 degrees C.), thus indicating normal operating conditions of the traction battery pack 18, the temperature sensor 68 may provide a first input signal to the control module 62. In response to receiving the first input signal, the control module 62 may command the pump 36 to operate at a first speed for circulating the coolant C through the coolant circuit 32. The first speed is sufficient to allow the gas separator 38 to remove any entrained gas G from the coolant C during the normal operating conditions.

When the temperature sensed by the temperature sensor 68 is greater than a predefined temperature threshold (e.g., about 60 degrees C.), thus indicating a likely battery thermal event within the traction battery pack 18, the temperature sensor 68 may provide a second input signal to the control module 62. In response to receiving the second input signal, the control module 62 may command the pump 36 to operate at a second speed that is greater than the first speed for circulating the coolant C through the coolant circuit 32. The second speed is sufficient to allow the gas separator 38 to efficiently remove the vent byproducts V from the coolant C during the battery thermal event.

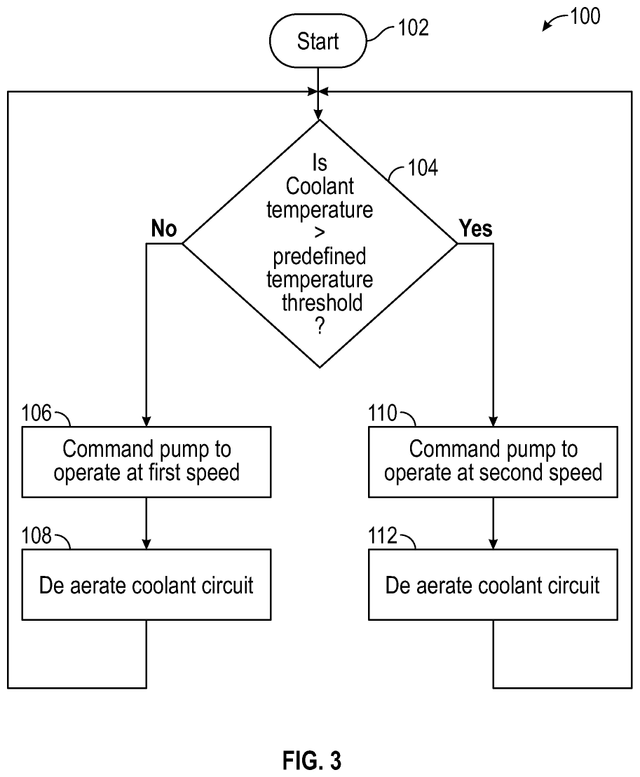

FIG. 3, with continued reference to FIGS. 1-2, schematically illustrates an exemplary method 100 for controlling the thermal management system 30 of the electrified vehicle 10. For example, the method 100 may be a control strategy for deaerating the coolant C during both normal operating conditions and during battery thermal events. The control module 62 may programmed with one or more algorithms adapted to execute the exemplary method 100, or any other control strategy associated with the thermal management system 30. For example, the method 100 may be stored as executable instructions in the memory 66 of the control module 62, and the executable instructions may be embodied within any computer readable medium that can be executed by the processor 64 of the control module 62.

The method 100 may begin at block 102. At block 104, the method 100 may determine whether the temperature of the coolant C exiting the traction battery pack 18 is greater than a predefined temperature threshold. When a NO flag is returned at block 104, the pump 36 may be commanded to operate at a first speed for circulating the coolant C through the coolant circuit 32 at block 106. The gas separator 38 may then deaerate the coolant circuit 32 by removing any entrained air from the coolant C at block 108.

Alternatively, when a YES flag is returned at block 104, thus indicating a battery thermal event, the method 100 may instead proceed to block 110. At this step, the pump 36 may be commanded to operate at a second, greater speed for circulating the coolant C through the coolant circuit 32. The gas separator 38 may then deaerate the coolant circuit 32 by removing any vent byproducts V contained within the coolant C at block 112. The method 100 may return to block 104 from either block 108 or 112 as part of a continuous, closed loop deaeration strategy.

The exemplary thermal management systems of this disclosure incorporate a gas separator and a reservoir that can be utilized in place of conventional degas bottle systems for removing and expelling gases from a coolant circuit of the system. The proposed systems are capable of removing gases from the coolant during both normal operating conditions and during battery thermal events that require increased coolant volume and flow rates for mitigating convective heat transfer.

In this disclosure, the term “about” means that the expressed quantities or ranges need not be exact but may be approximated and/or larger or smaller, reflecting acceptable tolerances, conversion factors, measurement error, etc.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A thermal management system for an electrified vehicle, comprising:
a traction battery pack;
a pump configured to circulate a coolant through the traction battery pack;
a gas separator configured to deaerate the coolant;
a reservoir configured to receive a gas removed from the coolant from within the gas separator; and
a control module programmed to configured to control the pump based on a temperature of the coolant exiting the traction battery pack.

2. The thermal management system as recited in claim 1, wherein the thermal management system is an immersion thermal management system.

3. The thermal management system as recited in claim 2, wherein the coolant is a dielectric fluid.

4. The thermal management system as recited in claim 1, wherein the gas separator is packaged at a first location of the electrified vehicle, and the reservoir is packaged at a second location of the electrified vehicle, and further wherein the second location is vertically higher than the first location.

5. The thermal management system as recited in claim 4, wherein the first location is near an outlet of the traction battery pack, and further wherein the second location is at a highest point of a coolant circuit of the thermal management system.

6. The thermal management system as recited in claim 1, wherein the gas includes air.

7. The thermal management system as recited in claim 1, wherein the gas includes a vent byproduct released by a battery cell of the traction battery pack.

8. The thermal management system as recited in claim 1, comprising a temperature sensor configured to sense the temperature.

9. The thermal management system as recited in claim 8, wherein the control module is programmed to command the pump to operate at a first speed when the temperature is less than a predefined temperature threshold.

10. The thermal management system as recited in claim 9, wherein the control module is programmed to command the pump to operate at a second, greater speed when the temperature is greater than the predefined temperature threshold.

11. The thermal management system as recited in claim 10, wherein the gas separator is configured to remove air from the coolant during the first speed and is further configured to remove a vent byproduct released by a battery cell of the traction battery pack during the second, greater speed.

12. The thermal management system as recited in claim 1, comprising a heat exchanger configured to cool the coolant prior to the coolant being returned to the traction battery pack.

13. The thermal management system as recited in claim 12, wherein the heat exchanger is a radiator.

14. A method, comprising:
circulating a coolant through a traction battery pack;
sensing a temperature of the coolant exiting from the traction battery pack;
controlling a pump to operate at a first speed when the temperature is less than a predefined temperature threshold;
removing air from the coolant within a gas separator when the pump is operated at the first speed;
controlling the pump to operate at a second speed that is greater than the first speed when the temperature is greater than the predefined temperature threshold; and
removing a vent byproduct released by a battery cell of the traction battery pack within the gas separator when the pump is operated at the second speed.

15. The method as recited in claim 14, comprising:
transferring the air to a reservoir; and
expelling the air to atmosphere from the reservoir.

16. The method as recited in claim 15, wherein the gas separator is packaged at a first location, and the reservoir is packaged at a second location that is vertically higher than the first location.

17. The method as recited in claim 14, comprising:
transferring the vent byproduct to a reservoir; and
expelling the vent byproduct to atmosphere from the reservoir.

18. The method as recited in claim 17, wherein the gas separator is packaged at a first location, and the reservoir is packaged at a second location that is vertically higher than the first location.

19. The method as recited in claim 14, wherein the temperature is sensed by a temperature sensor located at or near an outlet of the traction battery pack.

20. The method as recited in claim 14, wherein the gas separator is located between an outlet of the traction battery pack and an inlet of a heat exchanger.
